(19) United States
(12) Patent Application Publication
(10) Pub. No.: US 2022/0107009 A1
(43) Pub. Date: Apr. 7, 2022

(54) PULLEY AND CABLE ARRANGEMENT

(71) Applicants: GENESIS ROBOTICS AND MOTION TECHNOLOGIES, LP, Wichita, KS (US); GENESIS ADVANCED TECHNOLOGY INC., Surrey (CA)

(72) Inventors: James B. Klassen, Osoyoos (CA); Nathan Armstrong, Rocky View County (CA)

(73) Assignee: GENESIS ROBOTICS AND MOTION TECHNOLOGIES, LP, WICHITA, KS (US)

(21) Appl. No.: 17/418,892

(22) PCT Filed: Jan. 16, 2020
(86) PCT No.: PCT/IB2020/050353

§ 371 Date: Jun. 28, 2021

Related U.S. Application Data
(60) Provisional application No. 62/793,026, filed on Jan. 16, 2019.

(30) Foreign Application Priority Data
Oct. 17, 2019 (GB) 1915014.3

(51) Int. Cl. F16H 19/00; F16H 55/50

(52) U.S. Cl. CPC F16H 19/005; F16H 55/50

(57) ABSTRACT

A pulley system comprising: a first pulley rotatable about a first pulley axis, a first cable portion wrapped around the first pulley, such that, when the first pulley is rotated in a first direction about the first pulley axis, the first cable portion is unwound from the first pulley, and a second cable portion wrapped around the first pulley, such that, when the first pulley is rotated in the first direction about the first pulley axis, the second cable portion is wound further onto the first pulley, wherein the first and second cable portions form a continuous cable passing radially through the first pulley.

### FIELD OF THE DISCLOSURE

This disclosure relates to a pulley system, and to a robotic arm incorporating such a pulley system.

### Background

It is known to wrap bands and cables around pulleys in order to transfer torque or rotational motion between different locations and torque may be increased or decreased, and rotational speed increased or decreased, by using different sizes of pulley. However, cables and bands may also suffer from slippage relative to the pulleys, which may decrease the efficiency of the system.

Attempts have been made to attach cables to pulleys, where cables as opposed to bands are used. However, known connection methods, which include knotted cables abutting holes, involve bending cables through small radii and thereby imparting undesirably high stresses into the cable.

### SUMMARY OF THE INVENTION

According to a first aspect of the invention, there is provided a pulley system according to claim 1.

With such a pulley system, the number of cables required may be reduced, which may improve ease of manufacture. This method may also avoid the need for any knots to be formed in the cable, which may reduce the peak stress in the cable, thereby improving the longevity of the cable. Since tension in the two cable portions may be balanced to some extent, the strength of connection between the cable and the pulley may also be reduced.

The first pulley may have a helical groove and the first and second cable portions may lie in the groove. This may reduce the prospect of the cable overlapping itself and thereby increasing friction with the pulley, or varying the torque delivered to or from the pulley (by altering the mechanical advantage relative to an adjacent pulley). The helical groove may be a single continuous helix around the first pulley in which both of the cable portions lie.

The first pulley may be substantially cylindrical, and may comprise a passageway extending through the pulley in an axial direction, and the first and second cable portions may meet inside the passageway to form the continuous cable. By providing an axial passageway for connecting the first and second cable portions, the ends of each of the cable portions opposite the passageway, which may be wound around a second pulley, may depart from the first pulley at locations adjacent to each other and thereby internal stresses in the first pulley may be reduced and a more compact arrangement may be provided.

The pulley system may further comprise a second pulley, and the first and second cable portions may be wrapped around the second pulley such that rotation of the first pulley causes rotation of the second pulley, and, when the first pulley is rotated in the first direction, the first cable portion may be wound further onto the second pulley and the second cable portion may be unwound from the second pulley. By providing a second pulley, the pulley system may transfer torque between the two pulleys. Having a continuous cable passing through the first pulley and comprising cable portions wrapped around the second pulley can improve ease of assembly and durability of the arrangement.

According to a second aspect of the invention, there is provided a pulley system according to claim 5. With such a pulley system, two parallel cables may transfer torque between the pulleys, thereby allowing thinner cables to be used, which may reduce peak stresses in the cables due to bending. By using a single cable, which passes radially through the first pulley, a construction with improved manufacturability may be provided, in particular since the number of parts is lower. The strength of the cables may also be improved, as stress concentrations associated with knotted cables and applying adhesive to ends of cables may be avoided.

The first pulley may have a first helical groove and a second helical groove interleaved with the first helical groove, and the first and second cable portions may lie in the respective first and second helical grooves. By using helical grooves, the prospect of a portion of a cable overlapping itself is reduced, thereby providing a system having a more consistent torque response, and by interleaving the helical grooves, there is provided a more compact arrangement.

The first pulley may be substantially cylindrical and may comprise a passageway extending radially through the first pulley. Such a radial passageway allows the ends of the first and second cable portions to meet inside the pulley while keeping the opposite ends of the first and second cable portions together, and thereby provides a more compact arrangement.

The passageway may be a channel formed in an axial end surface of the pulley. This may allow the cables to be more easily arranged in the passageway and may provide a more easily manufacturable pulley.

The pulley system may further comprise a second pulley, wherein the first and second cable portions are wrapped around the second pulley such that rotation of the first pulley causes rotation of the second pulley, and, when the first pulley is rotated in a first direction, the first cable portion may be wound further onto the second pulley and the second cable portion may be wound further onto the second pulley. This may provide a compact arrangement for transferring torque between two adjacent pulleys.

The pulley system may further comprise a third cable portion wrapped around the first pulley, such that, when the first pulley is rotated in a first direction about the first pulley axis, the third cable portion is wound further onto the first pulley, and a fourth cable portion wrapped around the first pulley, such that, when the first pulley is rotated in the first direction about the first pulley, the fourth cable portion is wound further onto the first pulley, and the third and fourth cable portions may form a further continuous cable passing radially through the first pulley. This may provide a stronger arrangement for transferring torque from the first pulley.

The third and fourth cable portions may be substantially similar to the first and second cable portions respectively, and the further continuous cable may be substantially similar to the continuous cable. The first pulley may further comprise a second passageway extending radially through the first pulley, through which the further continuous cable may pass, which may be a channel formed in an axial end surface of the first pulley, opposite the axial end at which the first-mentioned passageway is formed.

The continuous cable and the further continuous cable may pass radially through the first pulley at axially opposite ends of the first pulley.

The pulley system may further comprise a second pulley, wherein the first, second, third and fourth cable portions may be wrapped around the second pulley such that rotation of the first pulley causes rotation of the second pulley, and, when the first pulley is rotated in the first direction the first and second cable portions may be wound further onto the second pulley and the third and fourth cable portions may be wound off from the second pulley.

One of the first and second cable portions may pass radially through the second pulley, and one of the third and fourth cable portions may pass radially through the second pulley, and the cable portions passing radially through the second pulley may be joined inside the second pulley such that the first, second, third and fourth cable portions may form a single continuous cable. This may further improve manufacturability of the pulley system, and may provide any of the advantages described above with reference to the first aspect.

The first and second cable portions may be fixed to the second pulley. Optionally, they may be fixed at their ends. This may reduce slippage of the cable portions relative to the second pulley and therefore may improve efficiency of torque transfer between the pulleys.

The first and second cable portions may be wound on the first pulley in substantially parallel helices. This may be the case even when no helical grooves are present.

The first cable portion may pass through a first void in an outer surface of the first pulley and the second cable portion may pass through a second void in an outer surface of the first pulley. The void may be a hole in a curved surface, leading to a central cavity or passageway or may be a recess, providing an entrance to a channel, the recess being formed at an axial end of the curved surface.

The continuous cable may be fixed to the first pulley at at least one point. This may reduce slippage of the cable portions relative to the first pulley and thereby improve the efficiency of the system.

The continuous cable may be fixed to the first pulley at a point inside the first pulley. This may allow the outer surface to remain smooth and allow an adhesive to be used which may surround the continuous cable. Thereby, the continuous cable may be more strongly fixed to the first pulley.

The continuous cable may not be fixed to the first pulley. The continuous cable may be freely wrapped around and may freely pass through the first pulley. This may reduce stress concentrations in the continuous cable, providing an even amount of tension throughout the cable, and may thereby improve the longevity of the cable. It may also allow even tension between cable portions connecting two pulleys.

The pulley system according to the first and/or second aspect may be incorporated into an actuator for a robotic system. The actuator may comprise a motor having a housing and a driveshaft and arranged to rotate the driveshaft relative to the housing and a first pulley system according to the first aspect, with the first pulley coupled to the drive shaft.

The first pulley system may further comprise a second pulley configured to be rotated due to rotation of the first pulley. The second pulley may be fixed on a second shaft, and the actuator may further comprise a second pulley system according to the second aspect, wherein the first pulley of the second pulley system is fixed to the second shaft.

The second pulley system may further comprise a second pulley and the second pulley of the second pulley system may be disposed around the motor and may be fixed to an outer side of the motor housing.

### BRIEF DESCRIPTION OF THE DRAWINGS

Embodiments of the invention will now be described, by way of example only, with reference to the accompanying drawings, in which:

FIG. 1 shows a general view of a pulley system;

FIG. 2 shows a cut-away view of a pulley and cable arrangement;

FIG. 3 shows a cut-away view of a pulley and cable arrangement according to the present disclosure;

FIG. 4 shows a general view of a pulley arrangement according to the present disclosure;

FIG. 5 shows a cable arrangement for use in a system according to the present disclosure;

FIG. 6 shows a pulley and cable arrangement according to the present disclosure;

FIG. 7 shows a pulley and cable arrangement according to the present disclosure, with one connector removed;

FIG. 8 shows a sectional view of a connector according to the present disclosure;

FIG. 9 shows a plan view of a connector according to the present disclosure; and

FIG. 10 shows an example of an actuator incorporating a pulley and cable system according to the present disclosure.

### DETAILED DESCRIPTION

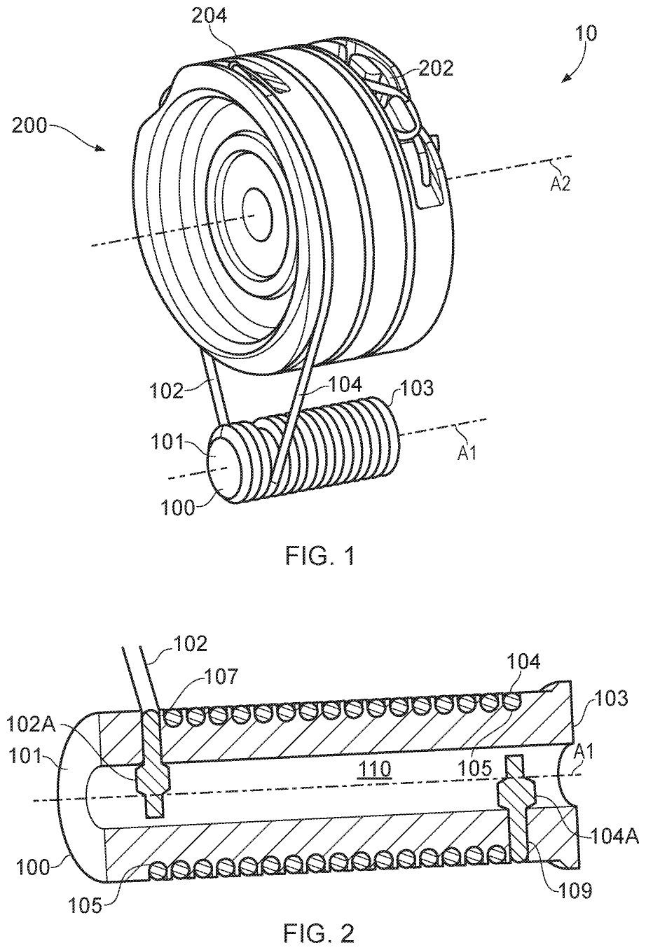

FIG. 1 shows a pulley arrangement 10, which may transfer torque from a first pulley 100 to a second pulley 200, the first pulley 100 being rotatable about a first pulley axis A1 and the second pulley 200 being rotatable about a second pulley axis A2. The first pulley 100 has a significantly smaller radius than the second pulley 200 and therefore, if a torque is applied to the first pulley 100, then a greater torque will be applied to the second pulley 200, with a lower rotational speed than the first pulley 100. However, the first pulley 100 may have a greater radius than that of the second pulley 200. In general, the first and second pulleys 100, 200 may have different radii.

The first pulley 100 has two cable portions wrapped around it: a first cable portion 102 and a second cable portion 104. The first and second cable portions 102, 104 are wrapped around both pulleys 100, 200 in a substantially helical fashion.

Looking to how the cable portions 102, 104 are wound around the first pulley 100, and starting from the point where the first and second cable portions 102, 104 depart from the first pulley 100, the first cable portion 102 extends away from this point along the first pulley 100 in a helix towards a first axial end 101 of the first pulley 100 and the second cable portion 104 extends away from this point in a helix towards a second axial end 103. The first and second cable portions 102, 104 therefore extend away from the point at which the first and second cable portions 102, 104 leave the first pulley 100 in opposite axial directions. It will be understood that, as the first pulley 100 rotates, the point at which the first and second cable portions 102, 104 depart from the first pulley 100 will move axially along the first pulley 100, as the cable portions 102, 104 are wound onto and off from the first pulley 100.

The first and second cable portions 102 and 104 are wound around the second pulley 200 such that, as the first and second pulleys 100, 200 rotate, the first and second cable portions 102, 104 are wound onto and off from the second pulley 200 corresponding to how they are wound off from and wound onto the first pulley 100. The first cable portion 102 is fixed to the second pulley 200 at a first mounting point 202 and the second cable portion 104 is fixed to the second pulley 200 at a second mounting point 204.

In this example, both the ends of cable portions 102, 104 are wound in a figure of eight around a double post cleat (i.e. two adjacent, substantially parallel posts extending from the surface of the pulley) at the respective mounting points 202, 204. With this configuration, it is possible to tension the cable during assembly, wrap the cable around the post cleats on the pulley while keeping the cable in tension, and to apply an adhesive such as cyanoacrylate to the cable before tension is removed. A free end of the cable may be pushed under the first loop of the figure of eight in order to provide a secure mechanical fixture for the cable in addition to the adhesive. The cable end may be trimmed after it is fixed.

The first and second pulleys 100, 200 may both have helical grooves arranged to receive the cable portions in order to provide a more consistent winding of the cables and to avoid overlapping of the cables onto themselves. The helical grooves on the larger of the two pulleys may be spaced more widely than the helical grooves on the smaller of the two pulleys, so that the portions of the cables extending between the two pulleys do not have a significant axial extent.

The helical grooves may have a depth greater than the diameter of the cable, such that the cables may lie entirely within the grooves. The depth of the grooves may be at least 50% greater than the diameter of the cable, optionally at least 80% greater.

FIG. 2 shows an arrangement for coupling the first and second cable portions 102, 104 to the first pulley 100. In this arrangement, each cable portion 102, 104 has a respective knot 102a, 104a, which prevents the cable portion ends from being pulled out of the pulley, which therefore may reduce slippage of the cable portions relative to the pulley 100.

However, construction of such knots 102a, 104a may be difficult as it requires a high level of dexterity to construct or tie such a knot in a confined space and the cables must be turned through a small radius in order to form said knots, meaning that the cables undergo significant bending stresses, which may weaken the cables.

The knots 102a, 104a may abut respective voids 107, 109 and may have diameters greater than the diameters of the voids 107, 109 so that the knots cannot be pulley through the voids 107, 109.

The voids 107, 109 may be formed so that their radially outer openings, on an outer surface of the first pulley 100, are within the helical groove 105. This may allow the cable portions 102, 104 to transition smoothly from being wound circumferentially around the first pulley 100 to passing radially through the first pulley 100 via the voids 107, 109.

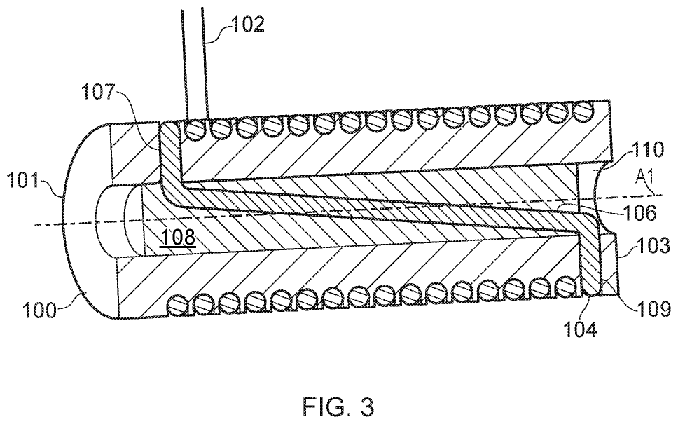

FIG. 3 shows a cut away view of a first pulley 100 according to the present invention. In this arrangement, the first cable portion 102 and second cable portion 104 form a continuous cable, which passes through an axial passageway 110 within the first pulley 100. This involves the addition of a further portion of cable 106, which lies within the passageway 110 and is integral with both of the first and second portions 102, 104. There is also provided an adhesive 108, arranged to fix the cable portion 106 within the passageway 110. The adhesive 108 may be an epoxy resin and may prevent slippage of the cable portions 102, 104, 106 relative to the pulley 100. Alternatively, in order to ensure that there is an even tension along the cable, the adhesive may be omitted.

As can be seen from FIG. 3, in this arrangement no knots are necessary and so no knots may be used and only a single continuous piece of cable is necessary, as opposed to two separate pieces of cable. Therefore, a greater level of manufacturability may be achieved.

The adhesive 108 may fill at least a portion of the length of the passageway 110 and may radially surround at least a portion of the cable 106 in the passageway.

The voids 107, 109 of the arrangement of FIG. 3 may be substantially the same as those described with reference to FIG. 2.

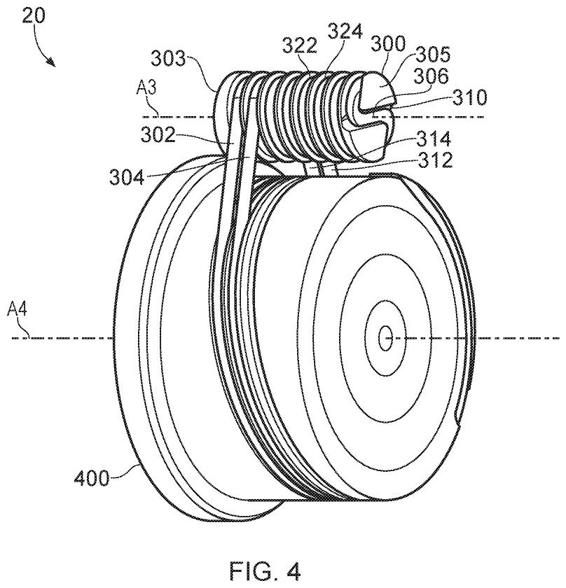

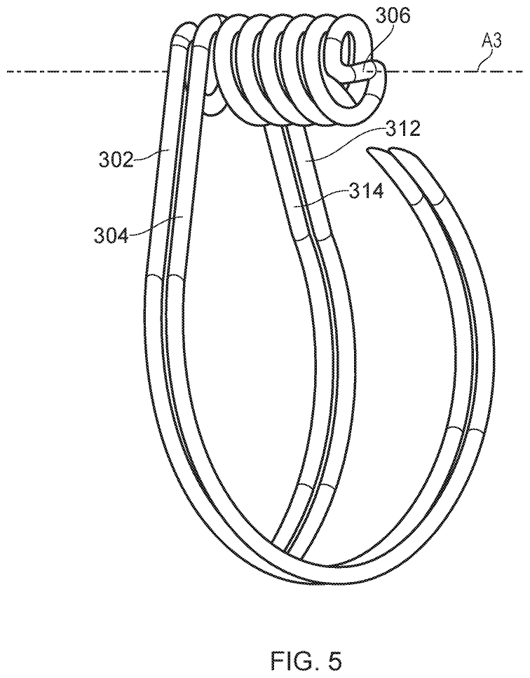

FIG. 4 shows a second pulley arrangement 20 comprising a first pulley 300 rotatable about a first pulley axis A3 and a second pulley 400 rotatable about a second pulley axis A4. The first pulley 300 and the second pulley 400 are coupled via a first cable portion 302, a second cable portion 304, a third cable portion 312 and a fourth cable portion 314. However, fewer cables may be present and in some embodiments only the first and second cable portions 302, 304 may be present.

Looking to the first and second cable portions 302, 304, these cable portions run parallel and may carry an equal tension, both being wound on to and wound off from the first and second pulleys 300, 400 together. The first and second cable portions 302, 304 may lie in different, parallel, interleaved helical grooves 322, 324 so as to be wound about the first pulley 300 in an alternating fashion. The helical grooves may have a depth greater than the diameter of the cable, as described above.

At a first axial end 305 of the first pulley 300, a further cable portion 306 may pass through a passageway 310 formed as a channel or trench in an axial end face of the pulley 300, which may connect the first and second cable portions 302, 304. As the tension in the first and second cable portions 302, 304 should theoretically be even, there may be no need to fix the further cable portion 306 to the passage 310, and indeed there may be no point at which any cable is fixed to the first pulley 300, which may be advantageous, as it may ensure equal tension between the first and second cable portions 302, 304. The first pulley 300 may further comprise a cover (not shown), covering the first end face 305, to enclose the passageway 310 and further cable portion 306. Alternatively, the passageway 310 may be open so that the cable portion 306 in the passageway 310 is externally visible.

The third and fourth cable portions 312, 314 may be substantially similar to the first and second cable portions 302, 304 and may be wrapped helically in interleaved helical grooves which may be the same helical grooves 322, 324 as the first and second cable portions 302, 304 are wound in around the first pulley 300, and joined at a second end face 303, opposite the first end face 305 in a manner substantially similar to how the first and second cable portions 302, 304 are joined. It will be understood that the third and fourth cable portions 312, 314 may be wrapped around the first pulley 300 such that they extend away from a point at which they depart from the first pulley 300 toward the second axial face 303, whereas the first and second cable portions 302, 304 extend in the opposite direction towards the first axial face 305. This may be analogous to how the first and second cable portions described with respect to FIG. 1 are wound, with the first and second cable portions 302, 304 shown in FIG. 4 being equivalent to the first cable portion 102 shown in FIG. 1 and the third and fourth cable portions 312, 314 shown in FIG. 4 equivalent to the second cable portion 104 shown in FIG. 1.

The first, second, third and fourth cable portions 302, 304, 312 and 314 may be wrapped around the second pulley 400 in a substantially helical manner and may be fixed to the second pulley 400. Alternatively, at least one of the cable portions may pass radially through the second pulley and adjoin one of the other cable portions, so that all four cable portions 302, 304, 312, 314 are connected as a single continuous cable.

FIG. 5 shows a cable arrangement of an embodiment in which two separate cables are used, one cable forming the first and second cable portions 302, 304 and one cable forming the second cable portions 312, 314. FIG. 5 shows only the cables and not the pulleys in order to illustrate how the cables may be wrapped.

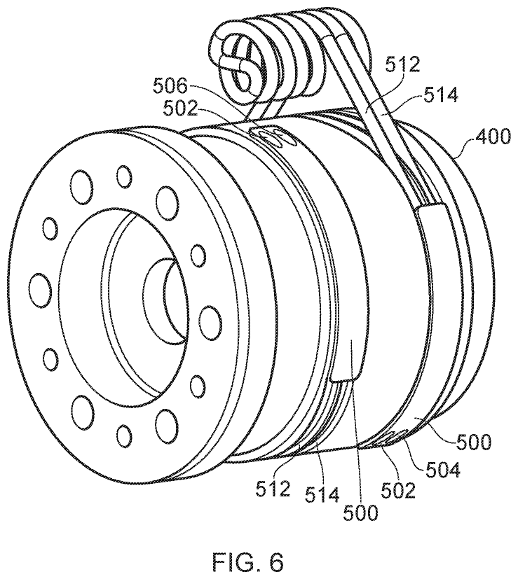

FIG. 6 shows a reverse view of the second pulley 400, showing how the cable portions may be connected to the second pulley 400 via connectors 500.

From FIG. 6, it can be seen that the connectors 500 are substantially curved, having a similar curvature to that of the outer surface of the second pulley 400 and have cable portions 512, 514 extending away from the connectors, the cable portions 512, 514 being between a body of the connector 500 and the second pulley 400, and the cable portions 512, 514 are connected to the connectors 500 at fixation points 502, 506, which are located on the connectors 500 at an opposite end from that at which the cable portions 512, 514 extend away from the connectors 500.

It will be understood that the cable portions 512, 514 may be the same cable portions as the first, second, third and fourth cable portions 302, 304, 312, 314 shown in FIGS. 4 and 5.

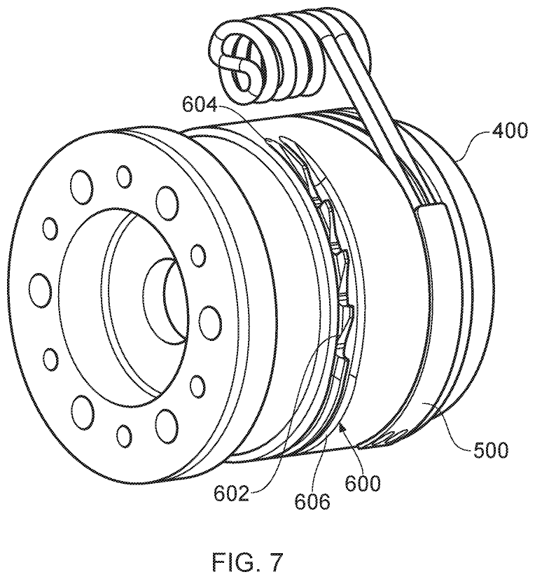

FIG. 7 shows the pulley 400 with one of the connectors 500 removed, exposing a receiving portion 600 for receiving the connector 500. The receiving portion 600 has two helical grooves 604, 606 for receiving the first and second cable portions 512, 514 and receiving teeth 602 for engaging with respective teeth of the connector 500.

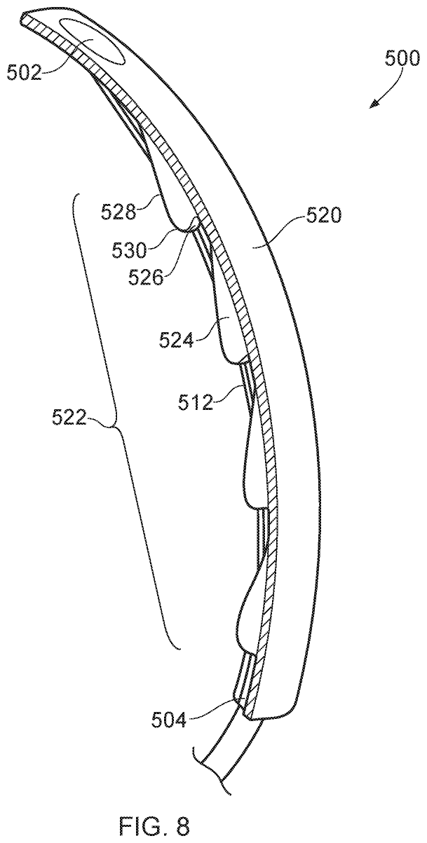

FIG. 8 shows a section view of a connector 500, with a portion removed. It can therefore be seen that the cable portion 512 extends along the length of the connector from a first fixation point 502. The connector 500 also comprises a body 520, which is a substantially flat, curved portion radially outside the cable portion 512, and which has a toothed portion 522 on a radially inner side, adjacent the cable portions 512.

The toothed portion 522 comprises teeth 524, each tooth having an engagement surface 526, facing a first direction away from the first fixation point 502 and substantially perpendicular to the body portion 520, and facing towards a second fixation point 504. Each tooth also has an angled surface 528, whose structure supports the engagement surface 526, and subtends an angle of between 20 and 60 degrees with the body portion 520 and a curved surface 530 joining the engagement surface 526 and the angled surface 528. Each tooth 524 may be solid and defined by the engagement surfaces 526, angled surface 528 and curved surface 530 and may extend away from the body portion 520.

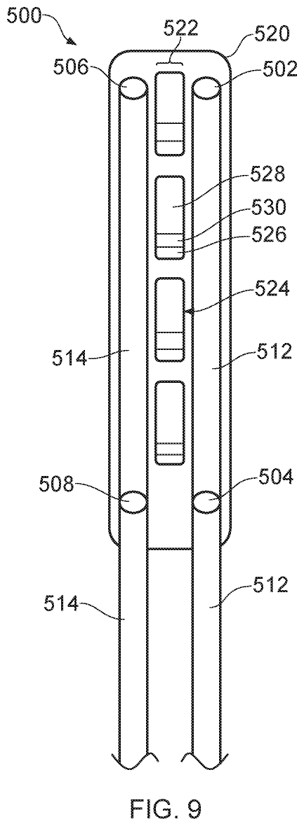

FIG. 9 gives a plan view of the connector 500, showing two cable parallel portions 512, 514 and the toothed potion 522 lying between the cables. The second cable portion 514 is also fixed to the connector 500 at two fixation points 506, 508, and the toothed portion 522 lies between the fixation points 502, 504, 506, 508. By providing such a symmetrical arrangement, stresses on the connector may be more equally balanced and bending forces on the teeth may be reduced.

The connector 500 may be formed by a moulding process, optionally an injection moulding process, and may be moulded around the cable portions 512, 514. The cable portions 512, 514 may be placed in the mould and maintained in tension as plastic is introduced into the mould and the plastic may diffuse through the fibres of the cables. By moulding the connectors in this way, a more consistent tension may be formed along the cables. The connectors 500 may thereby be formed with a level of residual stress, which manifests as a tensile stress in each of the cable portions 512, 514 and a compressive stress in the body portion 520.

Portions of excess cable may extend out of the mould in both directions (i.e. in both directions from the fixation point 502, 506) and these cable portions may be used to secure the connector 500 to the second pulley 400 and subsequently removed. The excess cable portions (not shown) may extend away from the fixation points 502, 506 and may be held in tension in order to resiliently couple the connector 500 to a pulley 400.

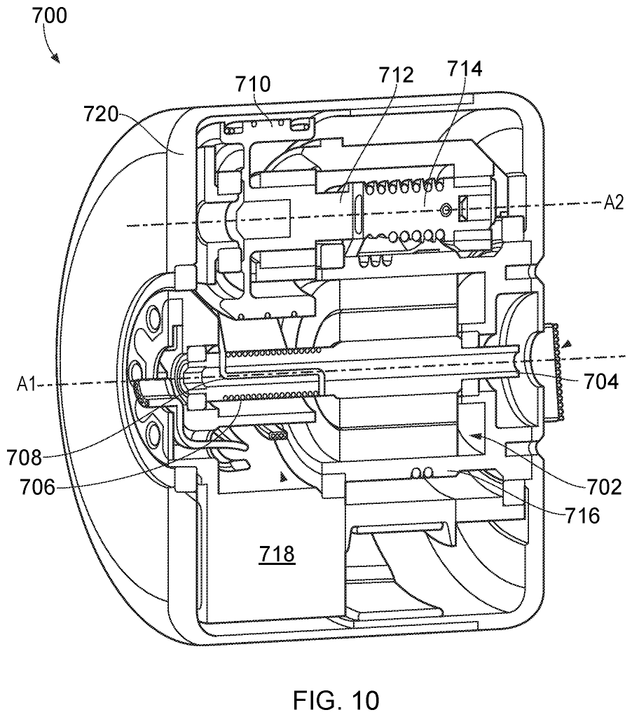

FIG. 10 shows an actuator 700, comprising a motor 702, the motor 702 being arranged to generate a torque to rotate a drive shaft 704. The drive shaft 704 is arranged to rotate a first pulley 706, which is coupled to a first cable 708, which passes radially through the first pulley 706. The first cable 708 is wrapped around and arranged to rotate a second pulley 710.

The second pulley 710 is fixed on a second shaft 712, which is supported by a second shaft mount 718, the second shaft mount 718 being arranged to rotate relative to the motor 702, and in particular to rotate relative to a housing of the motor 702. The second shaft 712 may thereby orbit the motor 702 or, where the second shaft mount 718 is fixed in position, the housing of the motor 702 may rotate.

The actuator 700 may also comprise a third pulley 714 fixed to the second shaft 712 and the third pulley 714 may be coupled to a fourth pulley 716 by a second, and optionally a third, cable (not shown).

The actuator may also comprise a housing 720, which may be arranged to encompass the pulleys 706, 710, 714, 716 and the motor 702 as well as the drive shaft 704, the second shaft 712 and the second shaft mount 718.

A further disclosure is set out in the following clauses:

A. A connector for coupling a cable to a pulley, comprising:
a toothed portion having a body and a plurality of teeth extending away from the body, the teeth each having an engagement surface facing a first direction, and
a cable portion, extending along the toothed portion and fixed to the toothed portion at a first fixation point, the cable portion extending away from the first fixation point and along the toothed portion in the first direction.

B. The connector of clause A, wherein the cable portion is fixed to the toothed portion at a second fixation point, the plurality of teeth being located between the first and the second fixation points.

C. The connector of clause A or B, wherein the cable portion is a first cable portion and
wherein the connector further comprises a second cable portion fixed to the toothed portion at a third fixation point, the cable portion extending away from the third fixation point and along the toothed portion in the first direction substantially parallel to the first cable portion.

D. The connector of clause C, wherein the second cable portion is fixed to the toothed portion at a fourth fixation point, the plurality of teeth being located between the third and the fourth fixation points.

E. The connector of clause C or D, wherein the plurality of teeth are located between the first and second cable portions.

F. The connector of any preceding clause, wherein the first and/or second cable portion terminates at the first and or third fixation point respectively.

G. The connector of any preceding clause, wherein the toothed portion is curved.

H. The connector of any preceding clause, wherein the toothed portion is less flexible than the cable portion.

I. The connector of any preceding clause, wherein each engagement face is substantially perpendicular to the body.

J. The connector of any preceding clause, wherein the engagement faces of the teeth each are normal to and lie along a circular arc.

K. The connector of any preceding clause, wherein the teeth are substantially triangular, each tooth having an angled face extending between the engagement face and the body.

L. The connector of clause K, wherein the angled faces meet the body at an angle of between 10° and 60°.

M. The connector of clause K or L, wherein the teeth each have a curved surface where the angled face meet the engagement face.

N. A pulley, having a cylindrical surface, the cylindrical surface having a receiving portion, the receiving portion having a toothed recessed arranged to receive the connector of any preceding clause.

O. The pulley of clause N, further comprising a helical groove arranged to receive the cable portion.

P. A pulley and cable system, comprising the pulley of clause N or O and the connector of any one of clauses A to M.

Q. A method of manufacturing a connector, the method comprising:
providing a mould for forming a connector portion;
inserting a cable portion through at least one wall of the mould; and
moulding a connector portion around the cable portion while the cable portion is held in tension in the mould, such that the connector portion is formed around the cable with a tensile residual stress in the cable.

R. The method of clause Q, wherein the cable portion extends through the connector portion, such that the cable portion extends away from the connector portion in two directions.

S. The method of clause Q or R, wherein the material used to form the connector portion diffuses through the fibres of the cable portion.

T. The method of clause Q, R or S, wherein the method forms a connector according to any one of clauses A to M.

U. A method of constructing the pulley and a cable system of clause P, comprising:
holding an excess cable portion extending from the first or third fixation point away from the connector portion,
moving the connector into engagement with the receiving portion while exerting tension on the excess cable portion; and
removing the excess cable portion after the connector is engaged with the receiving portion.

Although the invention has been described above with reference to one or more preferred embodiments, it will be appreciated that various changes or modifications may be made without departing from the scope of the invention as defined in the appended claims.

1. A pulley system comprising:
a first pulley rotatable about a first pulley axis,
a first cable portion wrapped around the first pulley, such that, when the first pulley is rotated in a first direction about the first pulley axis, the first cable portion is unwound from the first pulley, and
a second cable portion wrapped around the first pulley, such that, when the first pulley is rotated in the first direction about the first pulley axis, the second cable portion is wound further onto the first pulley,
wherein the first and second cable portions form a continuous cable passing radially through the first pulley.

2. The pulley system of claim 1, wherein the first pulley has a helical groove and wherein the first and second cable portions lie in the groove.

3. The pulley system of claim 1, wherein the first pulley is substantially cylindrical, comprising a passageway extending through the pulley in an axial direction, and
wherein the first and second cable portions meet inside the passageway to form the continuous cable.

4. The pulley system of claim 1, further comprising a second pulley,
wherein the first and the second cable portions are wrapped around the second pulley such that rotation of the first pulley causes rotation of the second pulley, and
wherein, when the first pulley is rotated in a first direction, the first cable portion is wound further onto the second pulley and the second cable portion is unwound from the second pulley.

5. A pulley system comprising:
a first pulley rotatable about a first pulley axis,
a first cable portion wrapped around the first pulley, such that, when the first pulley is rotated in a first direction about the first pulley axis, the first cable portion is unwound from the first pulley, and
a second cable portion wrapped around the first pulley, such that, when the first pulley is rotated in the first direction about the first pulley axis, the second cable portion is unwound from the first pulley,
wherein the first and second cable portions form a continuous cable passing radially through the first pulley.

6. The pulley system of claim 5, wherein the first pulley has a first helical groove and a second helical groove interleaved with the first helical groove, and
wherein the first and second cable portions lie in the respective first and second helical grooves.

7. The pulley system of claim 5, wherein the first pulley is substantially cylindrical and comprises a passageway extending radially through the first pulley.

8. The pulley system of claim 7, wherein the passageway is a channel formed in an axial end surface of the pulley.

9. The pulley system of claim 5, further comprising a second pulley,
wherein the first and the second cable portions are wrapped around the second pulley such that rotation of the first pulley causes rotation of the second pulley, and
wherein, when the first pulley is rotated in a first direction, the first cable portion is wound further onto the second pulley and the second cable portion is wound further onto the second pulley.

10. The pulley system of claim 5, further comprising:
a third cable portion wrapped around the first pulley, such that, when the first pulley is rotated in a first direction about the first pulley axis, the third cable portion is wound further onto the first pulley, and
a fourth cable portion wrapped around the first pulley, such that, when the first pulley is rotated in the first direction about the first pulley axis, the fourth cable portion is wound further onto the first pulley,
wherein the third and fourth cable portions form a further continuous cable passing radially through the first pulley.

11. The pulley system of claim 10, wherein the continuous cable and the further continuous cable pass radially through the first pulley at axially opposite ends of the first pulley.

12. The pulley system of claim 10, further comprising a second pulley,
wherein the first, second, third and fourth cable portions are wrapped around the second pulley such that rotation of the first pulley causes rotation of the second pulley, and
wherein, when the first pulley is rotated in a first direction, the first and second cable portions are wound further onto the second pulley and the third and fourth cable portions are off from the second pulley.

13. The pulley system of claim 12, wherein one of the first and second cable portions passes radially through the second pulley,
one of the third and fourth cable portions passes radially through the second pulley, and
the cable portions passing radially through the second pulley are joined inside the second pulley such that the first, second, third and fourth cable portions form a single continuous cable.

14. The pulley system of claim 9, wherein the first and second cable portions are fixed to the second pulley.

15. The pulley system of claim 5, wherein the first and second cable portions are wound on the first pulley in substantially parallel helices.

16. The pulley system of claim 5, wherein the first cable portion passes through a first void in an outer surface of the first pulley and the second cable portion passes through a second void in an outer surface of the first pulley.

17. The pulley system of claim 5, wherein the continuous cable is fixed to the first pulley at at least one point.

18. The pulley system of claim 17, wherein the continuous cable is fixed to the first pulley at a point inside the first pulley.

19. The pulley system of claim 5, wherein the continuous cable is not fixed to the first pulley.

20. The pulley system of claim 4, wherein the first and second cable portions are fixed to the second pulley.

21. The pulley system of claim 1, wherein the first and second cable portions are wound on the first pulley in substantially parallel helices.

22. The pulley system of claim 1, wherein the first cable portion passes through a first void in an outer surface of the first pulley and the second cable portion passes through a second void in an outer surface of the first pulley.

23. The pulley system of claim 1, wherein the continuous cable is fixed to the first pulley at at least one point.

24. The pulley system of claim 23, wherein the continuous cable is fixed to the first pulley at a point inside the first pulley.

25. The pulley system of claim 1, wherein the continuous cable is not fixed to the first pulley.
